(19) United States
(12) Patent Application Publication
(10) Pub. No.: US 2009/0108836 A1
(43) Pub. Date: Apr. 30, 2009

(54) Position Sensor

(75) Inventor: Takehide Nakamura, Handa-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/232,642

(22) Filed: Sep. 22, 2008

(30) Foreign Application Priority Data
Oct. 26, 2007 (JP) 2007-279008

(51) Int. Cl. G01B 7/30

(52) U.S. Cl. 324/207.17

(57) ABSTRACT

A position sensor comprises: a cosine coil and a sine coil as excitation coils which generate excitation signals; a detection coil which detects the excitation signal generated from the cosine coil and the sine coil; and a phase-difference detector serving as a converter that calculates a position of the detection coil based on the excitation signal detected by the detection coil. The cosine coil and the sine coil are plate-shaped conductors each including: a plurality of vertically bent segments which function as a coil; and connecting wire portions provided on both sides of the segments to connect the segments.

### CROSS-REFERENCE TO RELATED APPLICATIONS

This application is based upon and claims the benefit of priority from the prior Japanese Patent Application No. 2007-279008 filed on Oct. 26, 2007, the entire content of which is incorporated herein by reference.

### BACKGROUND OF THE INVENTION

1. Field of the Invention

The present invention relates to a position sensor that includes an excitation coil and a detection coil and arranged to calculate the position of the detection coil based on an excitation signal detected by the detection coil.

2. Description of Related Art

Heretofore, a high-power brushless motor has been employed in a hybrid electric vehicle or an electric vehicle. To control the brushless motor in the hybrid electric vehicle, it is necessary to accurately detect the rotational position of an output shaft of a motor. This is because the rotational position (rotation angle) of a rotor has to be detected in order to control switching of energization to each coil. In vehicles, particularly, cogging is apt to deteriorate driveability and hence there is a demand for reducing such cogging. For this end, accurate switching of energization is requested.

For detecting the position of a motor shaft of a vehicle, a resolver is used because of good high heat resistance, noise resistance, vibration resistance, high humidity, etc. The resolver is incorporated in the motor and directly attached to the rotor shaft.

One of such resolvers is a variable reluctance (VR) resolver. This VR resolver utilizes variations in transformer efficiency caused by changes in gap in a magnetic path. When the shape of a rotor is designed so that the gap periodically changes according to the rotational position, the rotational position can be detected without wirings in a rotor.

The currently available VR resolver is disclosed for example in JP8-178610(1996)A and JP6-229780(1994)A. In this configuration, an excitation coil and a detection coil are wound on each slot at one slot pitch. This enables realization of mechanical winding, resolver, synchro, and others.

However, the position sensors disclosed in JP8-178610(1996)A and JP6-229780(1994)A have the following disadvantages.

Specifically, the excitation coil that generates an excitation signal is made by winging a coil, which is difficult to manufacture and low in reliability, and high in cost.

### BRIEF SUMMARY OF THE INVENTION

The present invention has been made in view of the above circumstances and has an object to provide a position sensor easy to manufacture, high in reliability, and low in cost.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a position sensor comprising: an excitation coil which generates an excitation signal; a detection coil which detects the excitation signal generated from the excitation coil; and a position calculator which calculates a position of the detection coil based on the excitation signal detected by the detection coil, wherein the excitation coil is a plate-shaped conductor including: a plurality of vertically bent segments which function as a coil; and connecting wire portions provided on both sides of the segments to connect the segments.

According to the above position sensor, the excitation coil is made of a plate-shaped member obtained by pressing work, which needs no coil winding, makes it easy to manufacture, increases reliability of the excitation coil, and achieves low cost.

Preferably, in the above position sensor, the excitation coil is constituted of one of a sine coil and a cosine coil, and the segments have different widths.

Even if the segments are equal in width but arranged at different pitches (intervals), a sine coil and a cosine coil could be formed. However, such case is likely to cause a problem in integrally assembling the sine coil and the cosine coil by inserting the vertically bent segments of one of the coils into punched holes of the other coil.

In the case where the segments are equal in width but arranged at different pitches, the punched holes and the segments to be inserted therein are unlikely to be positioned in place. Particularly, this defect will be problematic in a position sensor reduced in size. Therefore the position sensor has to be increased in size. On the other hand, the position sensor of the invention configured that the segments are different in width but arranged at uniform pitches in portions corresponding to a section around a base (a midpoint between a peak and a bottom) of a sine curve and a cosine curve, so that the punched holes and the relevant segments can easily be positioned in place and hence the compact position sensor can be achieved.

The position sensor is preferably configured such that the sine coil and the cosine coil are placed one on the other so that distal ends of the vertically bent segments are positioned on the same level. The position accuracy of the vertically bent segments in the height direction relative to the rotor will directly exert an influence on the position accuracy of the position sensor. Accordingly, in assembling the sine coil and the cosine coil separately produced by pressing work as the excitation coils, it is important that the vertically bent segments of the sine coil and the vertically bent segments of the cosine coil coincide with each other in height.

Furthermore, the position sensor is preferably configured that the segments and the connecting wire portions are made by pressing work. Accordingly, the excitation coil can be energized simply by passing electric current to both ends of each coil (the connecting wire portions). In other words, no wiring is needed for the segments and hence easily manufacturable and inexpensive position sensor can be realized.

In the position sensor, preferably, the excitation coil and the detection coil are respectively formed in a loop pattern to detect the rotational position of the detection coil. Accordingly, the position sensor can be mounted on a motor shaft of a hybrid electric vehicle and others and used as a rotational position sensor.

Moreover, the current to be supplied to the excitation coil is a cosine wave expressed by a cosine curve or a sine wave expressed by a sine curve, which has been modulated at high frequency. If the sine wave or the cosine wave of several kHz is directly supplied to the plate-shaped segments obtained by press-punching, a sufficiently intense magnetic flux may not be generated. However, the sine wave or the cosine wave has been AM-modulated at high frequency of several hundred kHz, so that an intense magnetic flux can be generated by high frequency even by the plate-shaped segments.

In the case where the position sensor is mounted to a motor shaft of a hybrid electric vehicle and others, the position of the position sensor may vary in an axis direction of the motor shaft. However, according to the position sensor of the present invention, even when the rotor is displaced in the axis direction, such displacement is unlikely to affect the accuracy in detecting a rotational position.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a diagram showing entire configurations of a cosine coil and a sine coil and intensity of magnetic flux generated by each coil;

FIG. 2 is a partial view of the cosine coil in a manufacturing process thereof;

FIG. 3 is a partial view of the cosine coil;

FIG. 4 is a partial view of the sine coil in a manufacturing process thereof;

FIG. 5 is a partial view of the sine coil;

FIG. 6 is an enlarged partial view of the cosine coil of FIG. 2;

FIGS. 7A to 7C are enlarged partial views of the cosine coil of FIG. 3;

FIG. 8 is a view showing a relationship between a segment and a connecting wire portion;

FIG. 9 is a central sectional view of the cosine coil and the sine coil of FIG. 10 in an assembled state;

FIG. 10 is a view showing the cosine coil and the sine coil in the assembled state;

FIG. 11 is a perspective view of the cosine coil and the sine coil in the assembled state;

FIG. 12A is a sectional view of a body;

FIG. 12B is a sectional view of the body taken along a line A-A in FIG. 12A;

FIGS. 13A and 13B are views showing the cosine coil and the sine coil in the assembled state;

FIG. 14 is a view showing a state where the cosine coil and the sine coil are mounted in the body;

FIG. 15 is an enlarged partial view showing that the cosine coil is mounted in the body;

FIG. 16 is a perspective view of a stator of a resolver;

FIG. 17 is a perspective view of a rotor of the resolver;

FIG. 18 is a sectional view showing a positional relationship between the stator and the rotor of the resolver; and

FIG. 19 is a block diagram showing position detection control of the resolver.

### DETAILED DESCRIPTION OF THE PREFERRED EMBODIMENTS

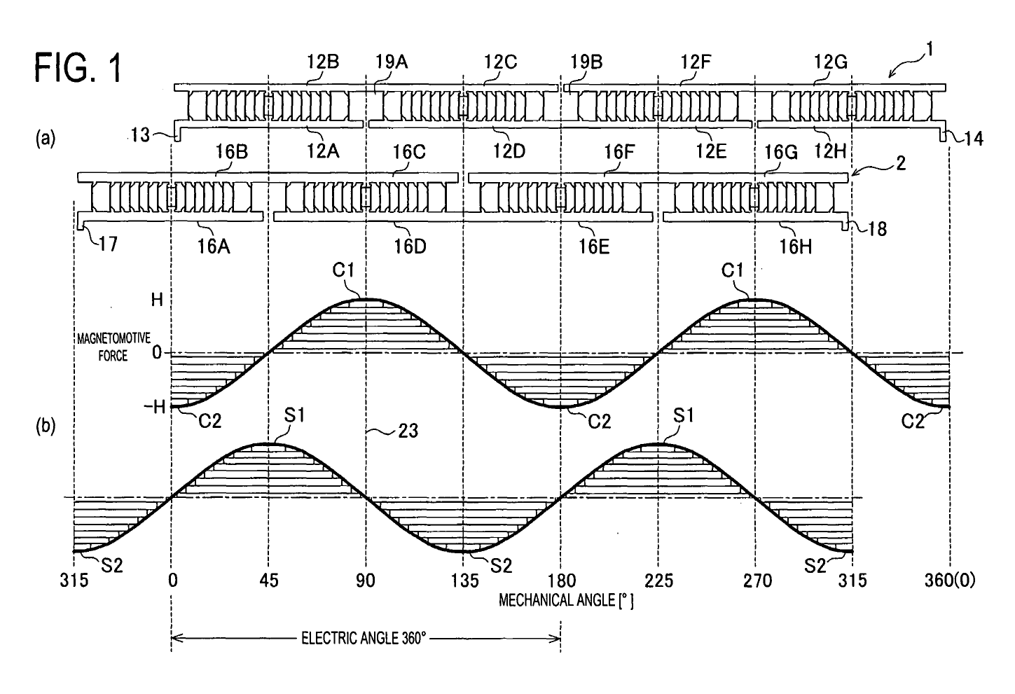

A detailed description of a preferred embodiment of a 2X position sensor embodying the present invention will now be given referring to the accompanying drawings. The configuration of an excitation coil and its manufacturing method will be explained with reference to FIGS. 1 to 8. In FIG. 1(a), an upper one shows the entire configuration of a cosine coil 1 and a lower one shows the entire configuration of a sine coil 2.

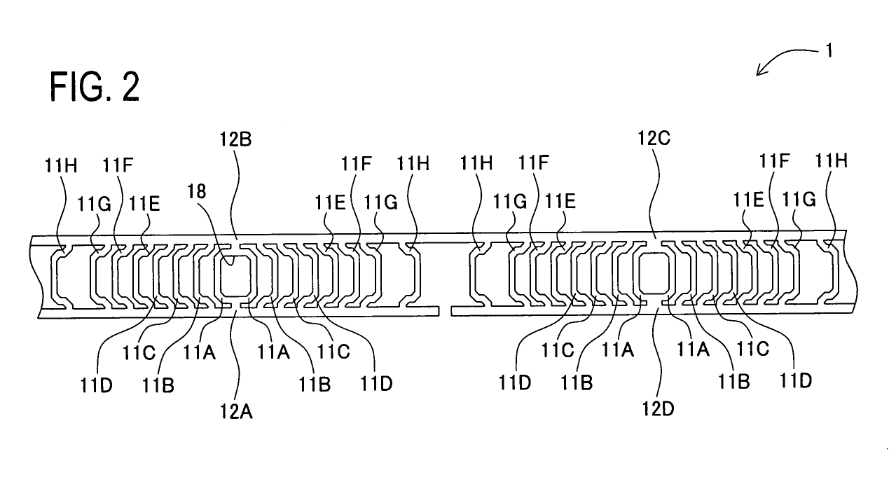

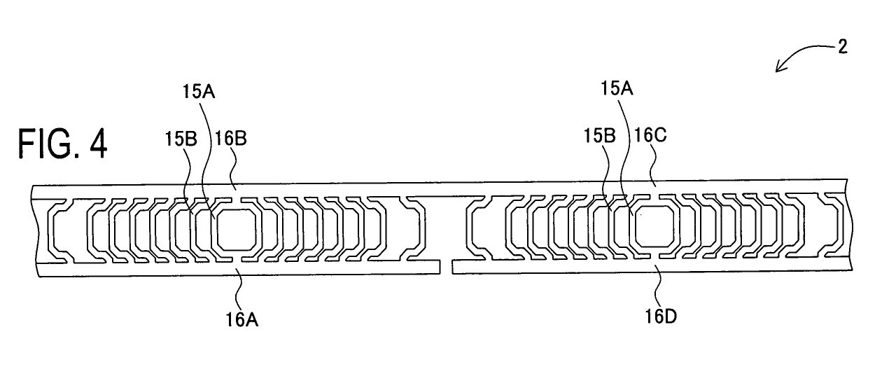

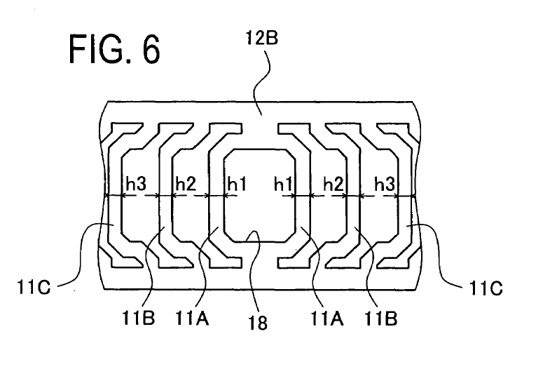

In a manufacturing process of the cosine coil 1 and the sine coil 2, a brass plate having a thickness of 0.3 mm in this embodiment is first subjected to press punching work. FIG. 2 is an enlarged partial view of the cosine coil 1 obtained by the press punching work and FIG. 4 is an enlarged partial view of the sine coil 2 obtained in the same way. The cosine coil 1 is formed with connecting wire portions 12A, 12B, 12C, and 12D on both sides. In the cosine coil 1, eight pairs (total sixteen) of segments 11 are formed to connect the connecting wire portions 12A and 12B. FIG. 6 is an enlarged partial view of the cosine coil 1 of FIG. 2. The eight segments 11A to 11H on one side are in symmetrical relation to those on the other side about the center line of a central hole 18.

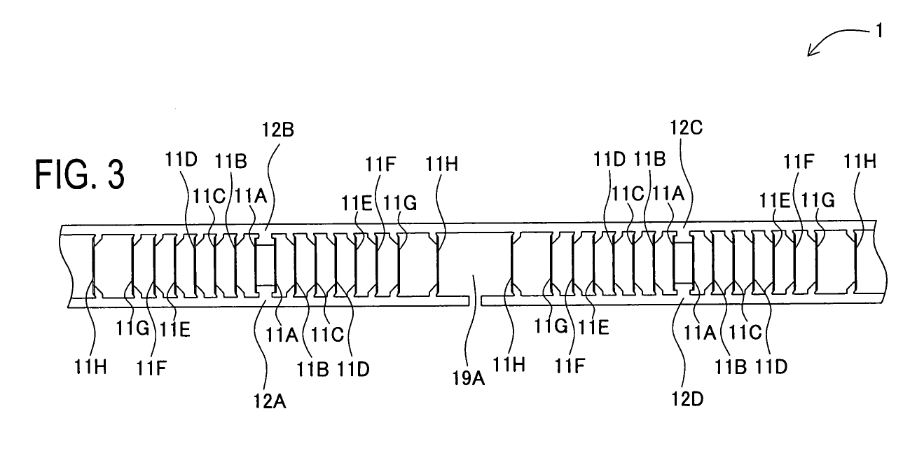

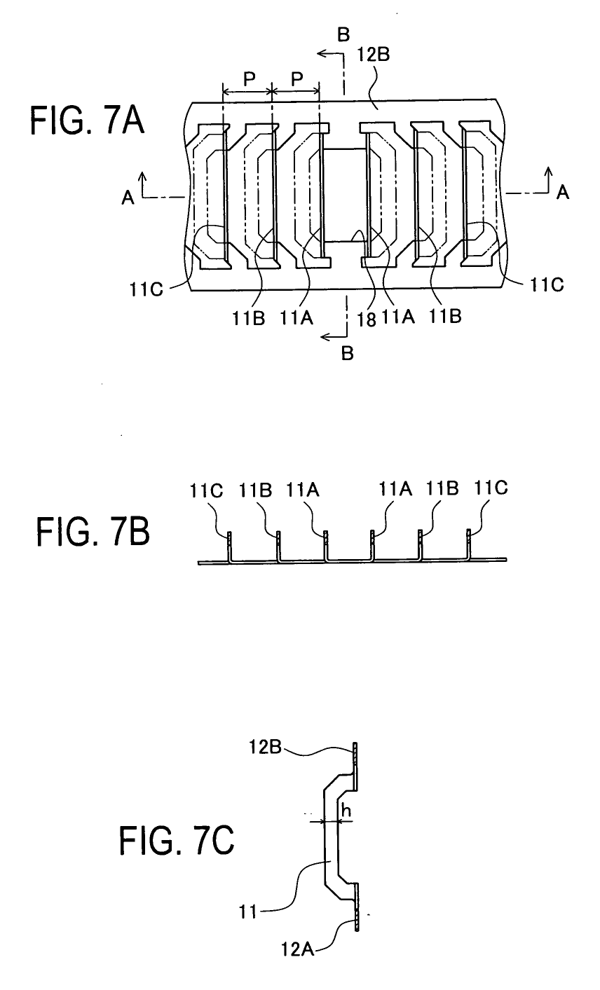

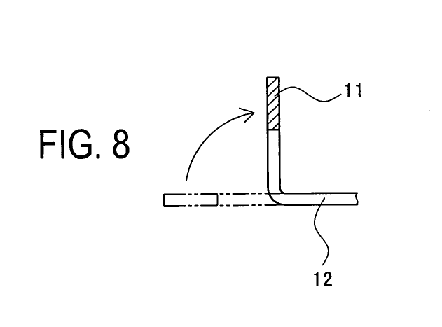

Secondly, sixteen segments 11A to 11H are bent vertically by pressing work with respect to each connecting wire portion 12A to 12D. The cosine coil 1 obtained by such pressing work is shown in FIG. 3. FIGS. 7A to 7C show the cosine coil 1 having the segments vertically bent, corresponding to a part shown in FIG. 6. Specifically, FIG. 7A is a front view of the cosine coil 1 corresponding to a part shown in FIG. 3, FIG. 7B is a bottom view, and FIG. 7C is a left side view. Each segment 11A to 11H is bent at a right angle at its base portion to stand perpendicular to each connecting wire portion 12A to 12D. FIG. 8 is an enlarged view showing a state where one of the segments 11A to 11H (hereinafter, also referred to as “11”) is bent at a right angle to one of the connecting wire portions 12A to 12D (hereinafter, also referred to as “12”).

The distal ends of the vertically bent segments 11 are located on the same level (height) as shown in FIG. 7B.

FIG. 4 shows the shape of the sine coil 2 obtained by the press punching work. The sine coil 2 is designed to be larger in outer width than the cosine coil 1. The sine coil 2 is formed with connecting wire portions 16A, 16B, 16C, and 16D on both sides. In the sine coil 2, eight pairs (total sixteen) of segments 15 (15A, 15B . . . ) are formed to connect the connecting wire portions 16A and 16B. The reference signs for the segments 15 are basically identical to those in FIG. 2 and thus only reference signs 15A and 15B are given in FIG. 4 and hereinafter referred to as “15”.

The height of each segment 15 of the sine coil 2 is designed to be higher than that of each segment 11 of the cosine coil 1 and hence at wider pitches in correspondence with the height of each segment 15.

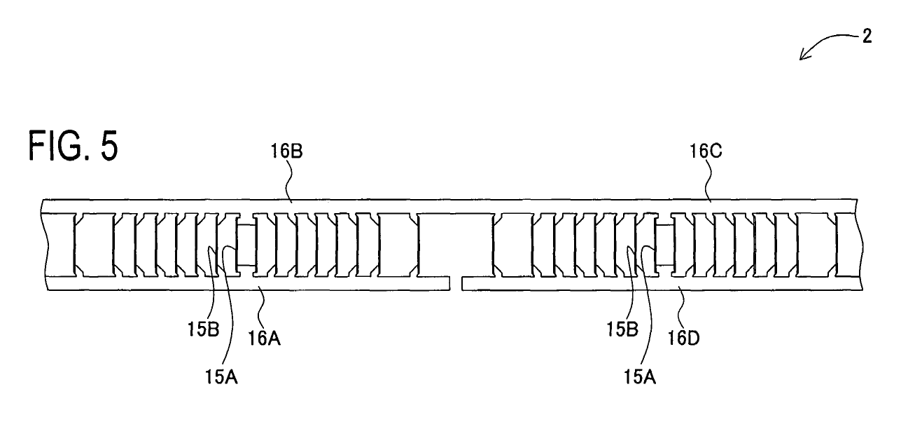

Sixteen segments 15 are bent by pressing work at right angles with respect to the connecting wire portions 16A to 16D respectively. The sine coil 2 obtained by such pressing work is shown in FIG. 5.

As shown in FIG. 1(a), the sine coil 2 and the cosine coil 1 are displaced from each other by an electrical angle of 90° out of phase.

The cosine coil 1 has an input end 13 at a left end and an output end 14 at a right end. Those input end 13 and output end 14 are connected to each other through the connecting wire portions 12A, 12B, 12C, 12D, 12E, 12F, 12G, and 12H in order.

The following assumes the case where an electric current flows from the connecting wire portion 12A to the connecting wire portion 12B. Eight segments on each side of the center line 23, i.e., total sixteen segments 11A to 11H are formed symmetric with respect to the center line 23. When an electric current flows the segments 11 from bottom to up in the figure, generating a magnetic field around the segments 11. The segments 11 are exactly positioned in place. Accordingly, the magnetic fields generated in sixteen places are summed up, the magnetic field generated by the cosine coil 1 is expressed as an upper cosine curve C1 shown in FIG. 1(b).

Specifically, the following assumes for example the current flowing through eight segments 11A to 11H corresponding to the right half of the currents flowing from the connecting wire portion 12A to the connecting wire portion 12B, and the current flowing through eight segments 11A to 11H corresponding to the left half of the currents flowing from the connecting wire portion 12C to the connecting wire portion 12D. Those currents form circumferentially flowing currents with respect to a gap 19A between the segments 11H and 11H facing each other and therefore generate a magnetic flux (the cosine curve C1) directed in a direction perpendicular to the drawing sheet from front to back.

Furthermore, the following assumes the current flowing through eight segments 11A to 11H corresponding to the right half of the currents flowing from the connecting wire portion 12C to the connecting wire portion 12D and the current flowing through eight segments 11A to 11H corresponding to the left half of the currents flowing from the connecting wire portion 12E to the connecting wire portion 12F. Those currents form circumferentially flowing currents with respect to a gap 19B between the facing segments 11H and 11H and therefore generates a magnetic flux (the cosine curve C2) directed in a direction perpendicular to the drawing sheet from back to front.

The above magnetic fluxes can define one cycle of the cosine curve.

In this embodiment, the shapes of the cosine curves C1 and C2 are rectified by using the segments 11 having different widths instead of arranging the segments 11 at different pitches.

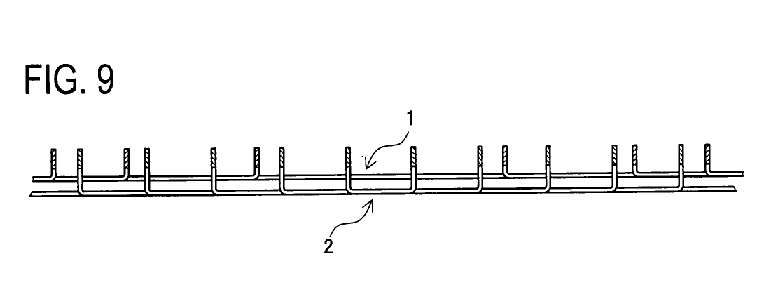

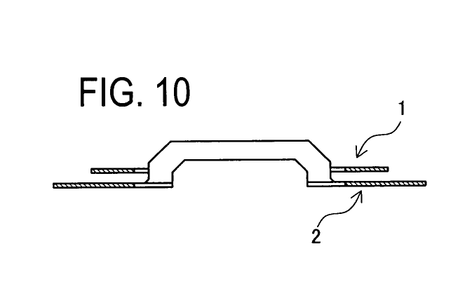

The sine coil 2 has a basically identical configuration to the cosine coil 1 excepting that the segments 15 are higher than those of the cosine coil 1 and are displaced by 90° out of phase from the segments 11 of the cosine coil 1. FIG. 10 shows the cosine coil 1 and the sine coil 2 in an assembled state. FIG. 9 is a cross sectional view of the assembled cosine coil 1 and sine coil 2 shown in FIG. 9.

On the other hand, the sine coil 2 has to be designed so that each segment 15 is higher than each segment 11 of the cosine coil 1 in order to assembly the cosine coil 1 and the sine coil 2 so that each segment 15 of the sine coil 2 is inserted in a punched hole formed in the cosine coil 1 as shown in FIGS. 9 and 10. The height of each segment 15 of the sine coil 2 and the height of each segment 11 of the cosine coil 1 have to be nearly equal in the assembled state. In other words, the distal ends of the segments 15 and 11 are located on the same level when the sine coil 2 and the cosine coil 1 are placed one on the other.

With such configuration, air gaps can be uniform from the rotor over its entire circumference. This enables correct measurement of rotation angles without needing compensation or correction by a circuit, thus eliminating the need for a compensation circuit, resulting in a reduced cost.

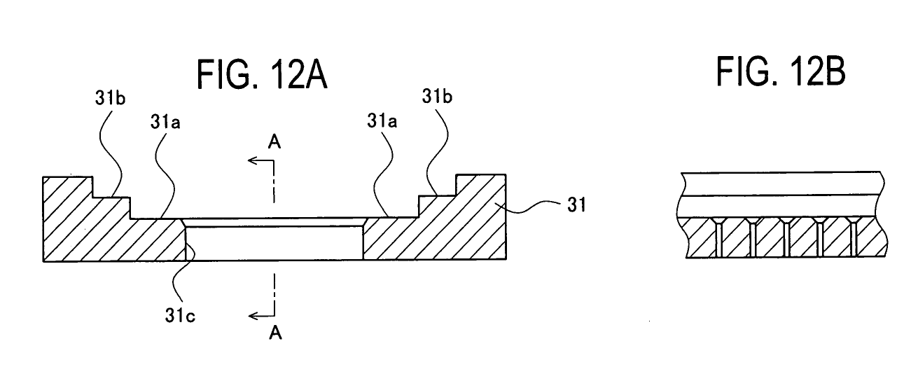

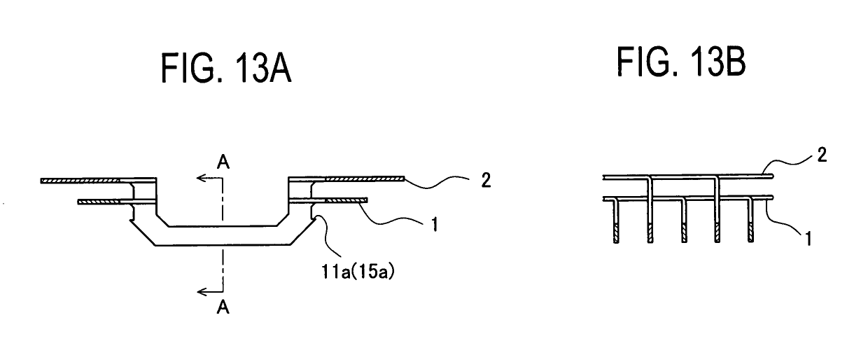

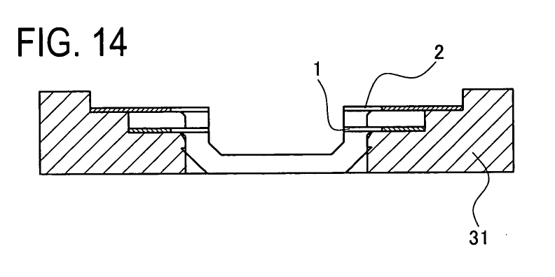

To maintain the air gaps at predetermined value, therefore, it is necessary to correctly position the segments 11 of the cosine coil 1 and the segments 15 of the sine coil 2. For this end, in this embodiment, a resin body 31 shown in FIG. 12A is used. FIG. 12B is a sectional view of the resin body 31 taken along a line A-A in FIG. 12A. The body 31 is formed with a hole 31c in which the segments 11 and 15 are inserted. The body 31 also includes, on both sides of the hole 31c, shoulder portions 31a for positioning the connecting wire portions 12 of the cosine coil 1 and shoulder portions 31b for positioning the connecting wire portions 16 of the sine coil 2. FIGS. 13A and 13B show the cosine coil 1 and sine coil 2 assembled to be mounted in the body 31; specifically, FIG. 13B is a sectional view of them taken along a line A-A in FIG. 13A. FIG. 14 shows the cosine coil 1 and sine coil 2 mounted in the body 31.

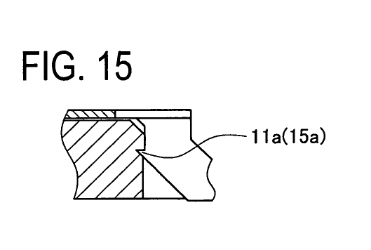

As shown in an enlarged partial view of FIG. 15, the segments 11 and 15 are formed with protrusions 11a and 15a which are engaged in recesses formed in the body 31 so that the height (position) of the distal ends of the segments 11 and 15 is fixed with respect to the body 31.

If the segments 11 of the cosine coil 1 are arranged at different (nonuniform) pitches to rectify the shapes of the cosine curves C1 and C2 and also the segments 15 of the sine coil 2 are arranged at different (nonuniform) pitches to rectify the shapes of the sine curves S1 and S2, the segments 11 of the cosine coil 1 and the segments 15 of the sine coil 2 may interfere with each other when the segments 15 are inserted in the punched holes of the cosine coil 1 in assembling the cosine coil 1 and the sine coil 2. To avoid the interference, the cosine coil 1 and the sine coil 2 have only to be increased to avoid such defects. However, another problem occurs that the entire size of a position sensor increases.

In this embodiment, to solve the above problems, the segments 11 are designed to have different width “h” shown in FIG. 6 from segment to segment. In other words, as the width h of the segment 11 is wider, a resistance value is lower, allowing a large amount of electric current to flow through the segment 11. On the other hand, as the width h is narrower, the resistance value is higher, allowing only a small amount of electric current to flow through the segment 11. The intensity of generated magnetic field is proportional to an amount of electric current flowing through the segment 11. Accordingly, in this embodiment, the segments 11 are designed to have different widths appropriately determined to rectify the shapes of sine curves S1 and S2 and the cosine curves C1 and C2.

It is to be noted that the segment width “h” is shown in FIG. 6 as h1, h2, and h3 for the segments 11A, 11B, and 11C. In this figure, the widths h1 to h3 appear to be equal in width but actually different, because actual differences therebetween are too small to be illustrated in the figure.

The following explanation will be given to a resolver in which the position sensor of this embodiment is incorporated. The resolver includes a stator, a rotor, and a control circuit.

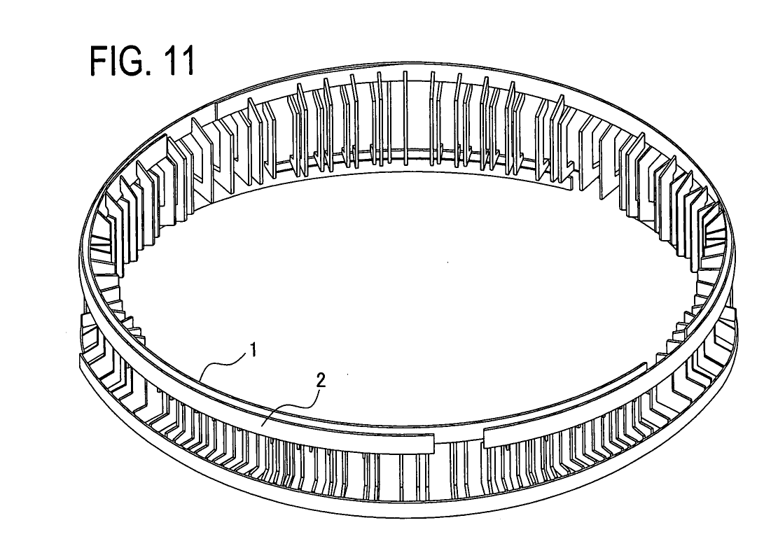

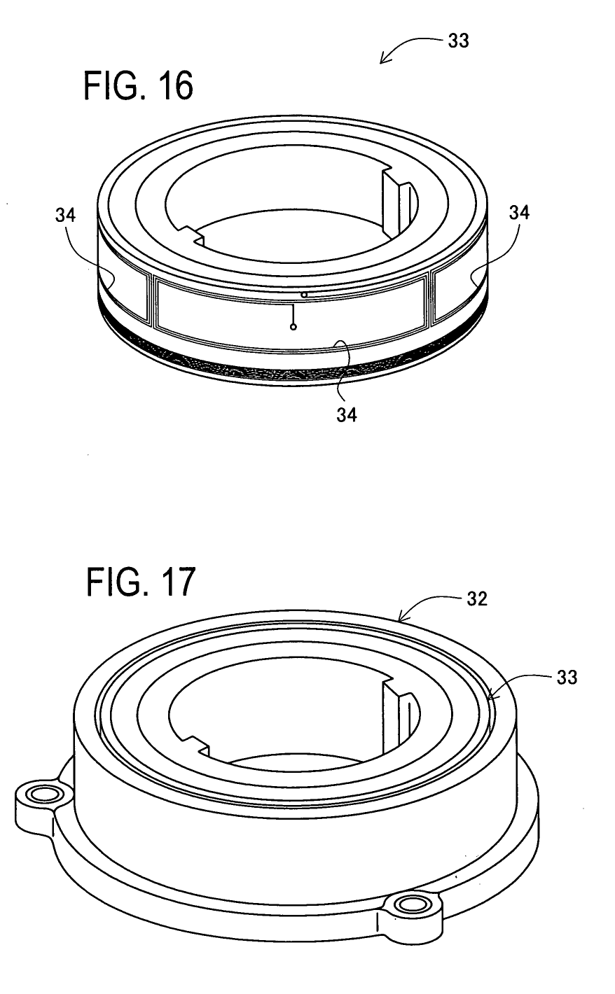

FIG. 17 is a perspective view of the resolver in which a rotor 33 is set in a stator 32 including the cosine coil 1 and the sine coil 2 mounted in the body 31. FIG. 16 shows the rotor 33 formed with four rectangular detection coils 34 on the outer periphery. The positional relationship between the cosine coil 1 and the sine coil 2 incorporated in the stator 32 in FIG. 17 is shown as a perspective view of FIG. 11.

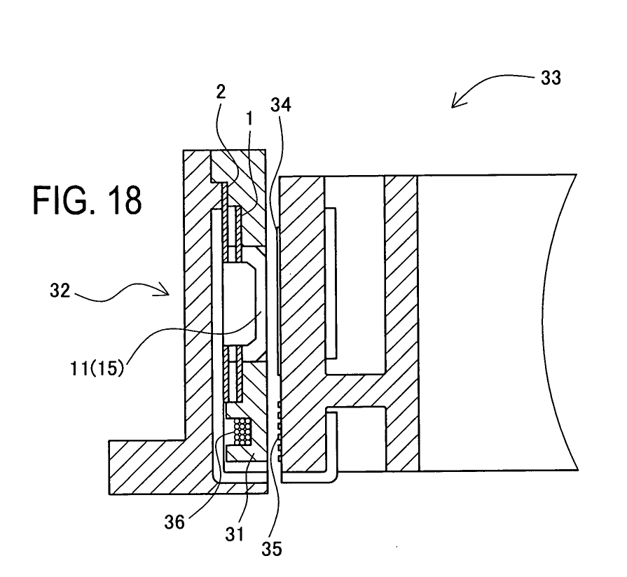

FIG. 18 is a sectional view showing a positional relationship between the cosine coil 1 and the sine coil 2 which are excitation coils of the stator 32 and the detection coils 34 of the rotor 33. The segments 11 of the cosine coil 1 and the segments 15 of the sine coil 2 are arranged with respective distal ends being circumferentially located along the inner surface of the stator 32. The detection coils 34 are placed in the rotor 33 to face the segments 11 and 15. On the other hand, coils 35 and 36 constituting a rotary transformer are fixed in the rotor 33 and the stator 32 respectively.

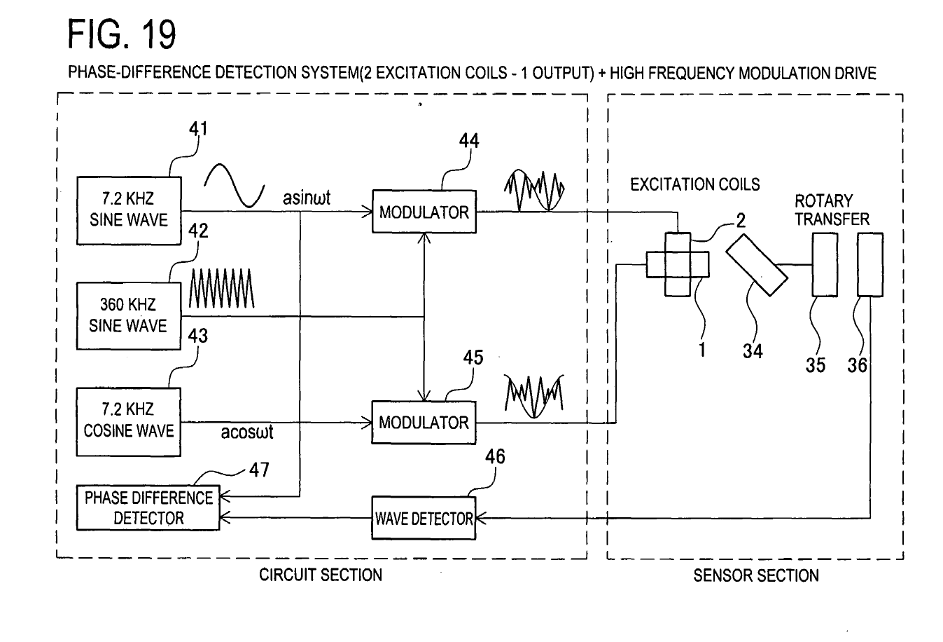

A control configuration of the resolver in which the position sensor of this embodiment is incorporated is shown in FIG. 19. A sine curve generator 41 for generating a sine curve of 7.2 kHz is connected to a modulator 44. A cosine curve generator 43 for generating a cosine curve of 7.2 kHz is connected to a modulator 45. A high-frequency generator 42 for generating a sine curve of 360 kHz is connected to the modulator 45. The modulator 44 is connected to the sine coil 2. The modulator 45 is connected to the cosine coil 1. The sine curve generator 41 and the cosine curve generator 43 are connected to a phase-difference detector 47 serving as a position calculator.

On the other hand, each detection coil 34 is connected to the rotary transformer coil 35. The other rotary transformer coil 36 is connected to a wave detector 46 which is connected to the phase-difference detector 47.

Operations of the resolver having the above configurations will be described below.

A sine curve generated by the sine curve generator 41 is subjected to for example AM balanced modulation (hereinafter, referred to as AM modulation) at high frequency in the modulator 44 and then flows in the sine coil 2. Simultaneously, a cosine curve generated in the cosine curve generator 43 is subjected to AM modulation at high frequency and then flows in the cosine coil 1.

As above, the cosine wave having been AM-modulated at high frequency is supplied to the cosine coil 1 and simultaneously the sine wave having been AM-modulated at high frequency is supplied to the sine coil 1. If the sine wave and the cosine wave each being 7.2 kHz are directly supplied to the plate-shaped segments 11 and 15 obtained by press punching work, a sufficiently intense magnetic flux may not be generated. However, the sine wave or the cosine wave has been AM-modulated at high frequency, so that an intense magnetic flux can be generated at high frequency even by the plate-shaped segments 11 and 15.

Consequently, the cosine coil 1 can produce the magnetic flux shown in an upper section in FIG. 1(b) and also the sine coil 2 can produce the magnetic flux shown in a lower section in FIG. 1(b).

In the excitation coils, the cosine curves C1 and C2 are generated and the sine curves S1 and S2 are generated. Thus, they form a superimposed curve. This superimposed curve has a magnetic flux intensity corresponding to each section of the stator 32. The rotational position (the rotation angle) of the rotor 33 can be detected accurately by the detection coils 34 that detect the magnetic flux intensity.

Specifically, induction current flows in the detection coils 34 according to the magnetic flux intensity. The intensity of the induction current is transmitted to the wave detector 46 via the rotary transformer coils 35 and 36 and then to the phase-difference detector 47. This detector 47 detects the rotational position of the rotor 33 based on the intensity of induction current and transmits a signal representing the rotational position of the rotor 33 to a controller not shown.

The position sensor of the present embodiment, as described above in detail, includes the cosine coil 1 and the sine coil 2 which are the excitation coils that generate excitation signals, the detection coils 34 which detect the excitation signals generated by the cosine coil 1 and the sine coil 2, and the phase-difference detector 47 serving as a position calculator that calculates the rotational position of the excitation coils according to the excitation signals detected by the detection coil 34. The cosine coil 1 and the sine coil 2 are plate-shaped conductors, each of which is constituted of the vertically bent segments 11 or 15 functioning as coils and the connecting wire portions 12 or 16 provided on both sides of the segments 11 or 15 to for wire connection. The excitation coil can be made up by the plate-shaped member obtained by pressing work without needing a coil winding. This makes it possible to facilitate manufacturing of a high-reliable and inexpensive excitation coil.

In the position sensor of the present embodiment, the segments 11 (15) are designed to have different widths, thereby forming the sine coil 2 or the cosine coil 1 as the excitation coils. It is possible to design those segments 11 and 15 to have the same widths and arrange them at different pitches to form the sine coil 2 and the cosine coil 1. However, such configuration is apt to cause a problem in assembling the sine coil 2 and the cosine coil 1 together by inserting the vertically bent segments 11 or 15 of one of the coils 1 and 2 into the punched holes of the other coil.

To be concrete, if the segments 11 and 15 having the same widths are arranged at different pitches, it is difficult to position the punched holes and the segments 11 or 15 in place. Such positioning is particularly hard for a position sensor reduced in size. Thus, the position sensor has to be increased in size.

On the other hand, as mentioned in the present embodiment, the segments 11 and 15 have different widths and are arranged at uniform pitches in the portions corresponding to a section around a base (a midpoint between a peal and a bottom) of each of the sine curves S1 and S2 and the cosine curves C1 and C2. Accordingly, the segments and the relevant punched holes can easily be positioned in place and hence a compact position sensor can be achieved.

In the position sensor of the present embodiment, the sine coil 2 and the cosine coil 1 are placed one on the other so that respective distal ends of the vertically bent portions are positioned on the same level (height). The position accuracy of the vertically bent segments 11 and 15 in the height direction relative to the rotor 32 will directly exert an influence on the position accuracy of the position sensor. Therefore, in assembling the sine coil 2 and the cosine coil 1 separately produced by pressing work as the excitation coils, it is important that the vertically bent segments 15 of the sine coil 2 and the vertically bent segments 11 of the cosine coil 1 coincide with each other in height.

In the position sensor of the present embodiment, the segments 11 and 15 and the connecting wire portions 12 and 16 are formed by pressing work. Accordingly, the excitation coils can be energized simply by passing current to end portions 13, 14, 17, and 18 of the connecting wire portions 12 and 16. In other words, no wiring is needed for the segments 11 and 15 and thus an easily manufacturable and inexpensive position sensor can be realized.

In the position sensor of the present embodiment, the cosine coil 1 and the sine coil 2 which are the excitation coils and the detection coils 34 are respectively formed in a loop pattern to detect the rotational positions of the detection coils 34. Accordingly, the position sensor can be mounted on a motor shaft of a hybrid electric vehicle and others and used as a resolver.

Furthermore, the current to be supplied to the cosine coil 1 and the sine coil 2 exhibits a cosine curve or sine curve that has been AM-modulated at high frequency. If the sine wave or the cosine wave of several kHz is directly supplied to the plate-shaped segments 11 and 15 obtained by press-punching, a sufficiently intense magnetic flux may not be generated. However, the sine wave or the cosine wave has been AM-modulated at high frequency of several hundred kHz, so that an intense magnetic flux can be generated by high frequency even by the plate-shaped segments 11 and 15.

In the case where the position sensor is mounted on a motor shaft of a hybrid electric vehicle and others, a rotor and a stator are displaced in an axis direction of the motor shaft. However, according to the position sensor of the present embodiment, even when the position of the rotor is dislocated from the stator in the axis direction, such displacement is unlikely to affect the accuracy in detecting a rotational position.

The present invention is not limited to the above embodiment(s) and may be embodied in other specific forms without departing from the essential characteristics thereof. For instance, the above embodiment exemplifies the case where the position sensor is applied to the resolver which is a rotation detector. As an alternative, the present invention may be applied to a linear position detecting sensor.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A position sensor comprising:
an excitation coil which generates an excitation signal;
a detection coil which detects the excitation signal generated from the excitation coil; and
a position calculator which calculates a position of the detection coil based on the excitation signal detected by the detection coil,
wherein the excitation coil is a plate-shaped conductor including: a plurality of vertically bent segments which function as a coil; and connecting wire portions provided on both sides of the segments to connect the segments.

2. The position sensor according to claim 1, wherein the excitation coil is constituted of one of a sine coil and a cosine coil, and the segments have different widths.

3. The position sensor according to claim 2, wherein the sine coil and the cosine coil are placed one on the other so that respective distal ends of the vertically bent segments are positioned on the same level.

4. The position sensor according to claim 1, wherein the segments and the connecting wire portions are made by pressing work.

5. The position sensor according to claim 1, wherein the excitation coil and the detection coil are formed respectively in a loop pattern to detect the position of the detection coil.

6. The position sensor according to claim 1, wherein an electric current to be supplied to the excitation coil is one of a cosine wave and a sine wave, which has been modulated at high frequency.
